(19) United States
(12) Patent Application Publication
(10) Pub. No.: US 2007/0038580 A1
(43) Pub. Date: Feb. 15, 2007

(54) Identity confirmation device

(76) Inventor: Chikezie Duke, Bronx, NY (US)

Correspondence Address: US CORPORATIONS, INC., P.O. BOX 234265, ENCINITAS, CA, 92023, US

(21) Appl. No.: 11/202,811

(22) Filed: Aug. 12, 2005

(51) Int. Cl. G06Q 99/00; H04L 9/00; H04K 1/00

(52) U.S. Cl. 705/64

(57) ABSTRACT

Identification software used by entering the identity number in a web application or reading the barcode in a network electronically in order to prove/disprove the authenticity of said identity and the current claim or disclaim of it nationally and internationally.

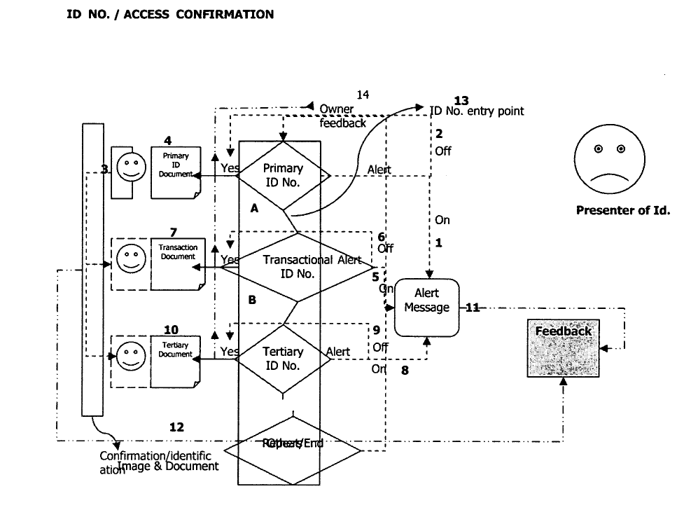

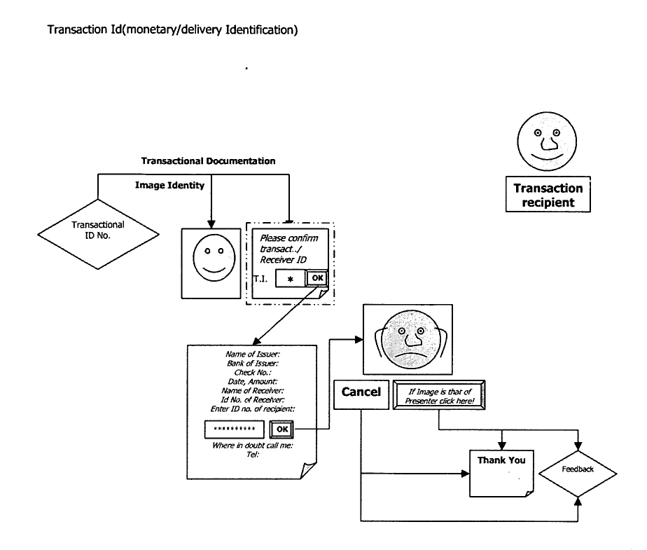

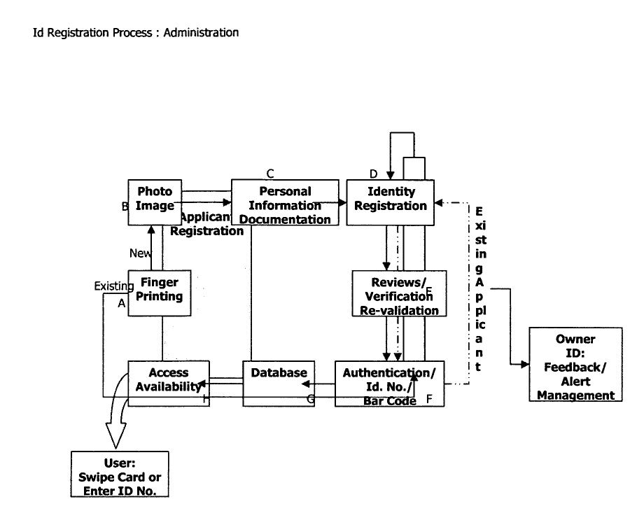

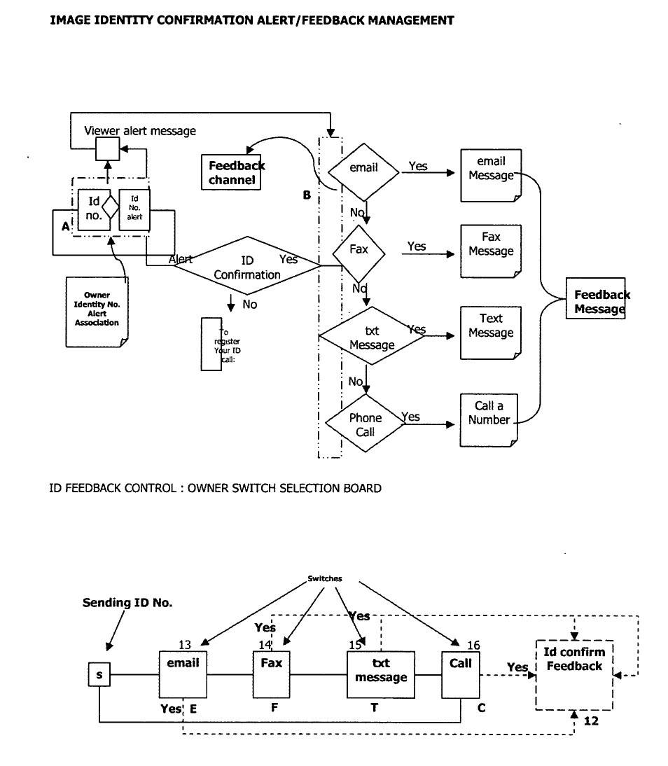

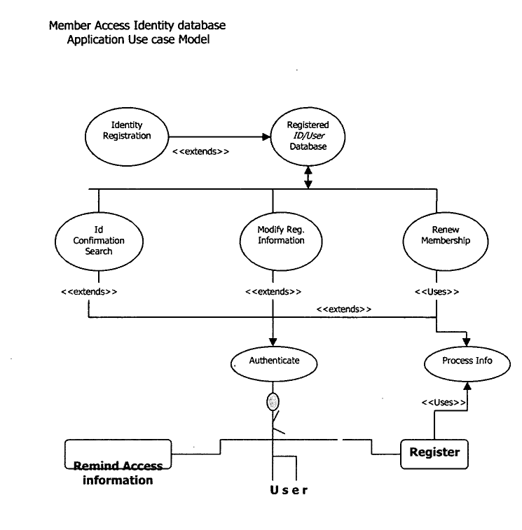

### CROSS-REFERENCE TO RELATED APPLICATIONS

Ser. No 60/504462

### STATEMENT REGARDING FEDERALLY SPONSORED RESEARCH OR DEVELOPMENT

Not applicable

### REFERENCE TO SEQUENCE LISTING

Not applicable

### BACKGROUND OF THE INVENTION

### Field of the Invention

The present invention relates, in general, to application/software designed to authenticate the identities of persons and property world wide electronically.

Currently, authentication of identities is limited to providers of such identities. Where the doubt of the authentic existence of the provider has been eliminated, prompt authentication of identities is slow, difficult and other times impossible. Also, expired or disclaimed identities are still very much in circulation and are used to gain access, claim benefit/entitlement enter into a bargain and accept delivery.

Used by entering the identity number in a web application or reading the barcode in a network electronically. Product is to be used by any individual, cooperation, employer, provider of services, hosts of events or functions, states and or nations, who for any reason is presented such an identity in order to prove/disprove the authenticity of said identity and the current claim or disclaim of it nationally and internationally.

A system for securing and validating the management and reporting of laboratory data wherein the taking of data at remote data-taking stations is denied absent electronic verification of both equipment and individual qualification, and wherein access to the data is denied absent electronic verification of individual authority.

The present invention relates to systems and methods for obtaining, modifying and certifying data. More specifically, it relates to systems for securing and validating the inputting, manipulating, accessing and certifying of individual and personal property data and information.

For security and management services, it is necessary to perform various identification tests and evaluations and maintain various records, then to manipulate the results of these tests and evaluations and prepare various reports that interpret and summarize those results. Such activities are generally performed in accordance with flight, credit job application, interviews, etc.

An example of such process may be as follows;

1. Mr. B through processed of registration of identities, confirmation and revalidation of is stored in the database and accessed either by name and/or number etc.

2. Identities on presentation are instantly checked without delays by signing on and entering the particulars. Mr. B presenting an identity associating him with the Prince of Wales will instantly be proved in the identity confirmation database.

3. Owners of identities are instantly informed of the submission of their identity in C, Y, Z location depending on what they signed on email, text message, fax etc.

4. Original owners of identities are instantly informed of the submission of their identity in X, Y, Z location depending on what they signed on(email, text message, fax, Call).

Several computer-based data management systems specifically intended for use in such analytical purposes have been designed over the years and are known generically as internal database systems. While these systems often archive the identification results, and provide reports, they are usually oriented too late in the process to insure original data integrity.

The inventors believe that a critical need exists to capture, validate and secure personal identification data as close to the source as possible. Technology is needed which performs this function with simple input or questions and clear interfaces for personnel and immediate identification.

Under presently intended procedures, authorized analysts are provided with SOP's and, using instrumentation, perform the aforementioned tests and manually record the aforementioned data in accordance therewith. Once all data has been collected, it is transcribed into a batch record within a computer for interpretation and manipulation, and thereafter, for compilation into such reports as might be dictated by the SOP. The agency, auditor, or interviewer can view the report(s), while simultaneously viewing the subject and the supporting data to interpret the report and judge identification.

The approval and certification identity, such as the social security number, generally require the performance of such evaluations and the production of such identity reports in conjunction with only national databases. Performance of these tests, access to the resulting data, and ability to manipulate are strictly limited to only national databases eliminating the ability to identify individuals outside of the United States.

Personal identification systems of some sort have always been essential tools in such research and development of identification software involved with testing and reporting.

An object of the present invention is to provide a method and software for identifying individuals from all nations and nationalities with one given number or barcode within one general database.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and. scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new identity confirmation device and method which has many of the advantages of the devices mentioned heretofore and many novel features that result in a identity confirmation device which is not anticipated, rendered obvious, suggested, or even implied by any of the prior art software, either alone or in any combination thereof.

It is another object of the present invention to provide a new identity confirmation device which may be easily and efficiently manufactured and marketed.

It is a further object of the present invention to provide a new identity confirmation device which is of a durable and reliable software format.

An even further object of the present invention is to provide a new identity confirmation device which is susceptible of a low cost of manufacture with regard to both materials and labor, and which accordingly is then susceptible of low prices of sale to the consuming public, thereby making such identity confirmation device economically available to the buying public.

Still yet another object of the present invention is to provide a new identity confirmation device which provides in the apparatuses and methods of the prior art some of the advantages thereof, while simultaneously overcoming some of the disadvantages normally associated therewith.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### ILLUSTRATIONS

(Attached)

We claim:

1. An identity confirmation device and method which will instantly provide an image and document confirmation, providing identification feedback to the identity owner.

2. An identity confirmation device and method according to claim 1, wherein the proper identification holder will be notified if another individual attempts to use their identity.

3. An identity confirmation device and method according to claim 1, wherein the device will allow multiple identifications for one individual such as state, national or associated group membership.

4. An identity confirmation device and method according to claim 1, wherein 3^{rd} parties such as financial or corporate institutes can secure identification.

5. An identity confirmation device and method according to claim 1, wherein the format of the device is in the form of software to be used within any network compatible computer system.
